(19) United States
(12) Patent Application Publication
(10) Pub. No.: US 2014/0069552 A1
(43) Pub. Date: Mar. 13, 2014

(54) DOCKING DEVICE FOR MATERIAL BOTTLES

(71) Applicant: SHENZHEN CHINA STAR OPTOELECTRONICS TECHNOLOGY CO., LTD, Shenzhen, Guangdong (CN)

(72) Inventors: Ming Liu, Shenzhen (CN); Tao Ding, Shenzhen (CN); Guodong Zhao, Shenzhen (CN); Tao Song, Shenzhen (CN); Tao Ma, Shenzhen (CN); FangFu Chen, Shenzhen (CN)

(73) Assignee: SHENZHEN CHINA STAR OPTOELECTRONICS TECHNOLOGY CO. LTD., Shenzhen, Guangdong (CN)

(21) Appl. No.: 13/806,141

(22) PCT Filed: Aug. 30, 2012
(86) PCT No.: PCT/CN2012/083746

§ 371 Date: Dec. 21, 2012

(30) Foreign Application Priority Data
Oct. 24, 2012 (CN) 201220548347.6

(51) Int. Cl. B67C 9/00

(52) U.S. Cl. CPC B67C 9/00
USPC 141/364

(57) ABSTRACT

The present disclosure provides a docking device for material bottles used for guiding material in a first material bottle to flow into a second material bottle. The docking device includes a sleeve with two ends thereof being respectively engageable with mouths of the first material bottle and the second material bottle and a protrusion configured in the sleeve for guiding the material in the first material bottle to flow into the second material bottle. With the sleeve, the two material bottles can be docked together, thus, the material in one material bottle can be poured into the other material bottle quickly. Meanwhile, the protrusion configured in the sleeve can guide the flowing material to avoid side leakage when the material flows from one material bottle into the other material bottle along the inner wall of the sleeve.

### BACKGROUND

1. Technical Field

The present disclosure relates to connecting structures, and particularly, to a docking device for material bottles.

2. Description of Related Art

In displaying industries such as the TFT-LCD industry or the OLED industry, material like liquid, liquid crystal, colloid, or emulsion is often used. The material is generally held in material bottles (containers). Some of the material may be left over on the bottoms of the material bottles (containers). In order to increase the utilization rate, make full use of the material, and save cost, before the used material bottle (container) is abandoned, the material remained in the material bottle (container) is poured into a new one such that the remained material can be used in following procedures.

Since the designs of the material bottles are identical to each other and diameters of the mouths of the material bottles (the mouths of the containers) are equal to each other, thus, one material bottle can be inclined towards the other material bottle at an acute angle relative to the horizontal plane, but cannot be inclined towards the other material bottle at 90 degrees relative to the horizontal plane. Additionally, a circular-arc-shaped (oval-arc-shaped) connecting portion is often configured between the inner wall and the mouth of the material bottle (a connecting portion is often configured between the inner wall and the mouth of the container), which takes a long time to pour the material remained in one material bottle (container) into the other material bottle (container) and results in left-over material more or less.

### SUMMARY

One aspect of the present disclosure is to provide a docking device for material bottles which allows the material in one material bottle to be poured into the other material bottle completely and avoids side leakage during the process.

The docking device for material bottles is used for guiding material in a first material bottle to flow into a second material bottle. The docking device includes a sleeve with two ends thereof being respectively engageable with mouths of the first material bottle and the second material bottle and a protrusion configured in the sleeve for guiding the material in the first material bottle to flow into the second material bottle.

Preferably, external threads are formed on the mouth of the first material bottle and/or the mouth of the second material bottle, and internal threads are formed on an inner wall of the sleeve for engaging with the external threads on the mouth of the first material bottle and/or the mouth of the second material bottle.

Preferably, one end of the sleeve is shaped as a trumpet and the other end thereof is shaped as a straight pipe.

Preferably, both ends of the sleeve are shaped as straight pipes.

Preferably, grooves are formed in an inner wall of the sleeve.

Preferably, the mouths of the first material bottle and the second material bottle respectively abut two sides of the protrusion.

Preferably, the protrusion is a ring protruding from an inner wall of the sleeve, or the protrusion is at least two arcs of a same circumference protruding from an inner wall of the sleeve.

Preferably, the protrusion is formed by recessing the sleeve inwards or the protrusion is formed by protruding the sleeve inwards.

Preferably, a supporting surface and an abutting surface extend from the inner wall of the sleeve, the protrusion is surrounded by the supporting surface, the abutting surface, and the inner wall of the sleeve; or a supporting surface and a abutting surface extend from the inner wall of the sleeve, a connecting surface connects the supporting surface and the abutting surface, and the protrusion is surrounded by the supporting surface, the abutting surface, and the connecting surface.

Preferably, the supporting surface and the abutting surface extend towards one end of the sleeve from the inner wall of the sleeve; or the abutting surface extends towards one end of the sleeve from the inner wall of the sleeve and the supporting surface extends towards the other end of the sleeve from the inner wall of the sleeve.

The present disclosure further provides another docking device for material bottles used for guiding material in a first material bottle to flow into a second material bottle. The docking device includes a sleeve and an annular protrusion. The sleeve has an inner wall and two ends. The inner wall forms grooves allowing for air convection between the docking device and external environment and the two ends are respectively engageable with mouths of the first material bottle and the second material bottle. The annular protrusion is configured in the sleeve for guiding the material in the first material bottle to flow into the second material bottle.

Preferably, external threads are formed on the mouth of the first material bottle and/or the mouth of the second material bottle, and internal threads engageable with the external threads formed on the mouth of the first material bottle and/or the mouth of the second material bottle are formed on the inner wall of the sleeve.

Preferably, one end of the sleeve is shaped as a trumpet and the other end thereof is shaped as a straight pipe.

Preferably, both ends of the sleeve are shaped as straight pipes.

Preferably, the mouth of the first material bottle is received in one end of the sleeve, and the other end of the sleeve is received in the mouth of the second material bottle.

Preferably, the protrusion is formed by recessing the sleeve inwards or by protruding the sleeve inwards.

Preferably, a supporting surface and an abutting surface extend from the inner wall of the sleeve, the protrusion is surrounded by the supporting surface, the abutting surface, and the inner wall of the sleeve; or a supporting surface and an abutting surface extend from the inner wall of the sleeve, a connecting surface connects the supporting surface and the abutting surface, and the protrusion is surrounded by the supporting surface, the abutting surface, and the connecting surface.

Preferably, the supporting surface and the abutting surface extend towards one end of the sleeve from the inner wall of the sleeve; or the abutting surface extends towards one end of the sleeve from the inner wall of the sleeve and the supporting surface extends towards the other end of the sleeve from inner wall of the sleeve.

The present disclosure still further provides yet another docking device for material bottles used for guiding material in a first material bottle to flow into a second material bottle. The docking device includes a sleeve having two ends for respectively receiving the mouths of the first material bottle and the second material bottle and a protrusion configured in the docking device for guiding the material in the first material bottle to flow into the second material bottle. Two sides of the protrusion respectively abut the mouths of the first material bottle and the second material bottle.

Preferably, the protrusion is formed by recessing the sleeve inwards of by protruding the sleeve inwards.

With the sleeve having two ends being respectively engageable with the mouths of two material bottles, the docking device of the present disclosure allows the mouths of two material bottles to be docked together, that is, one material bottle can be inclined towards the other material bottle at 90 degrees relative to the horizontal plane. Thus, the material in one material bottle can be poured into the other material bottle quickly. Meanwhile, the protrusion configured in the sleeve is capable of guiding the flowing material to avoid side leakage when the material flows from one material bottle into the other material bottle along the inner wall of the sleeve; on the other hand, the protrusion is capable of preventing the corresponding material bottle from being inserted into the other material bottle too much due to its own gravity and further preventing the first material bottle from falling down due to the unstable center of gravity when being docked to the second material bottle.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view illustrating a docking device for material bottles in accordance with a first embodiment of the present disclosure;

FIG. 2 is a schematic view illustrating a docking device for material bottles in accordance with a second embodiment of the present disclosure;

FIG. 3 is a schematic view illustrating a docking device for material bottles in accordance with a third embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

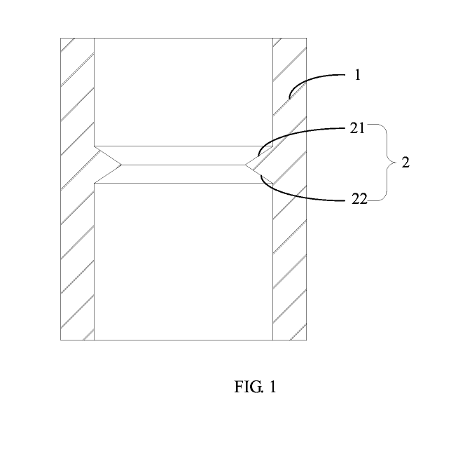

Referring to FIG. 1, a docking device for material bottles in accordance with a first embodiment is schematically shown. The docking device for material bottles is used for guiding material in a first material bottle to flow into a second material bottle. The docking device includes a sleeve 1 and a protrusion 2 configured in the sleeve 1. Two ends of the sleeve 1 are respectively engageable with mouths of the first and second material bottles. During the process of pouring material from one material bottle into the other material bottle, the mouth of the first material bottle is connected to one end of the docking device and the mouth of the second material bottle is inserted into the other end of the docking device. In this way, most of the material in the first material bottle can be poured into the second material bottle via the mouth of the first/second material bottle, and the rest of the material can be poured into the second material bottle through the protrusion 2. On one hand, the protrusion 2 is capable of guiding the material to avoid side leakage when the material flows into the second material bottle along an inner wall of the sleeve 1; on the other hand, the protrusion 2 is capable of preventing the first material bottle from being inserted into the sleeve 1 too much due to its own gravity and further preventing the first material bottle from falling down due to unstable center of gravity when being docked to the second material bottle.

In a specific embodiment, that the two ends of the sleeve 1 are respectively engageable with the mouths of the first and second material bottles may specifically refer to: the inner diameter of one end of the sleeve 1 is engageable with the outer diameter of the mouth of the first material bottle, and the inner diameter of the other end of the sleeve 1 is engageable with the outer diameter of the mouth of the second material bottle, wherein “engageable” means clearance fit which is convenient for disassembly and capable of avoiding swaying. In other embodiments, that the two ends of the sleeve 1 are respectively engageable with the mouths of the first and second material bottles may refer to: the inner diameter of one end of the sleeve 1 is engageable with the outer diameter of the mouth of the first material bottle, and the outer diameter of the other end of the sleeve 1 is engageable with the inner diameter of the mouth of the second material bottle, wherein “engageable” means clearance fit which is convenient for disassembly and capable of avoiding swaying.

The two ends of the sleeve 1 of the docking device of the present disclosure are capable of engaging with the mouths of the two material bottles, which allows the mouths of the two material bottles to be docked to each other. That is, the two material bottles can be inclined towards each other at 90 degrees relative to the horizontal plane. In this way, the material in one material bottle can be poured into the other material bottle quickly. Meanwhile, on one hand, the protrusion 2 configured in the sleeve 1 is capable of guiding the material to avoid side leakage when the material flows from one material bottle into the other material bottle along the inner wall of the sleeve 1; on the other hand, the protrusion 2 is capable of preventing the corresponding material bottle from being inserted into the other material bottle too much due to its own gravity and further preventing the first material bottle from falling down due to the unstable center of gravity when being docked to the second material bottle.

The mouth of a conventional material bottle is often provided with external threads or internal threads. In a specific embodiment, when external threads are formed on the mouth of the first material bottle and/or the mouth of the second material bottle, internal threads being engageable with the external threads are correspondingly formed in the inner wall of the sleeve 1 according to the shape of the sleeve 1. With the engagement between the external threads formed on the corresponding material bottle (the first material bottle and/or the second material bottle) and the internal threads formed in the sleeve 1, the docking device can be mounted to the material bottles. When pouring material in a number of other material bottles into one specific material bottle, the docking device can be mounted to the specific material bottle and can be prevented from swaying and falling down relative to the specific material bottle, thus, the material can be poured into the specific material bottle conveniently.

Correspondingly, when external threads are formed on the mouth of the first material bottle and/or the mouth of the second material bottle, the sleeve 1 can form internal threads in the inner wall thereof for engaging with the external threads according to the shape of the sleeve 1. It is noted that the configuration of the sleeve 1 is not limited to the above description. In some embodiments, threads can be formed in both inner wall and outer wall of the sleeve 1.

In a specific embodiment, the two ends of the sleeve are shaped as straight pipes, of which at least one end is configured with external threads or internal threads.

In a specific embodiment, when two material bottles are docked to each other through the docking device of the present disclosure, air convection among the two material bottles and the docking device and external environment is reduced, which may slow down the flowing speed of the material from one material bottle into the other material bottle. Thus, in a specific embodiment, the inner wall of the sleeve 1 is further configured with grooves for guaranteeing the air convection among the two material bottles, the docking device, and external environment, which increases the flowing speed of the material from one material bottle into the other material bottle.

In a specific embodiment, the protrusion 2 can be a ring protruding from the inner wall of the sleeve 1 or two arcs of a same circumference located on the inner wall of the sleeve 1. The number of the arcs is not limited to two, and can be three or four or more than four according to requirements.

In a specific embodiment, the protrusion 2 is formed by protruding the sleeve 1 inwards.

In a specific embodiment, when the first material bottle is docked to the second material bottle via the docking device, the mouths of the first and second material bottles respectively abut two sides of the protrusion 2.

In a specific embodiment, a supporting surface 21 extends from the inner wall of the sleeve 1 towards one end of the sleeve 1 and an abutting surface 22 extends from the inner wall of the sleeve 1 towards the other end of the sleeve 1. The protrusion 2 is surrounded by the supporting surface 21, the abutting surface 22 and the inner wall of the sleeve 1. That is, a cross section of the protrusion 22 is a triangle which is preferably an isosceles triangle. When the first material bottle is docked to the second material bottle via the docking device, some of the material in the first material bottle flows into the second material bottle through the supporting surface 21. The mouths of the first and second material bottles respectively abut the supporting surface 21 and the abutting surface 22. With the configuration, the two ends of the docking device can be used without being distinguished to be an upper end and a lower end (a left end and a right end). That is, the two ends of the sleeve 1 can be used regardless of which end corresponding to the material bottle from which the material is poured and which end corresponding to the material bottle collecting the material.

It is noted that the mouths of the first and second material bottles are not limited to the above configurations. In some embodiments, the mouth of the first material bottle may not contact the supporting surface 21 and the mouth of the second material bottle may not contact the abutting surface 22.

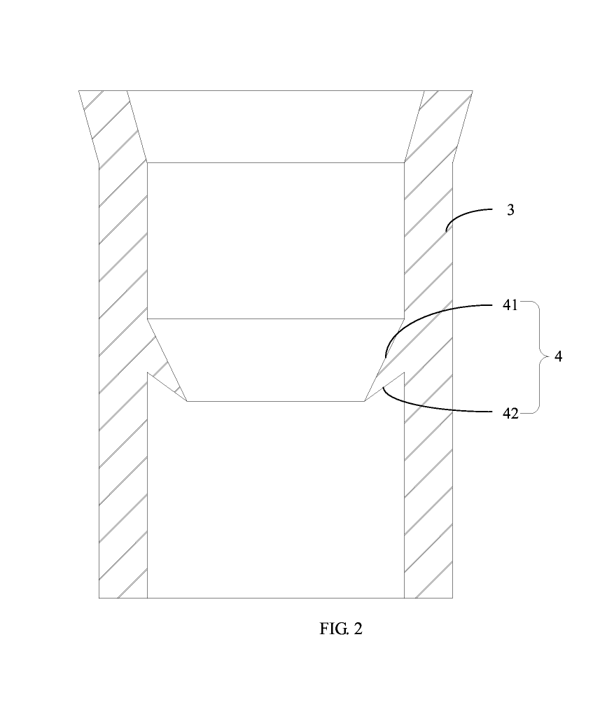

Referring to FIG. 2, a docking device for material bottles in accordance with a second embodiment is shown. The docking device of the second embodiment is modified based on that of the first embodiment. The docking device of the embodiment includes a sleeve 3 with one end thereof being shaped as a trumpet and the other end thereof being shaped as a straight pipe. The end of the sleeve 3 shaped as a straight pipe is provided with external threads engageable with the internal threads formed on the mouth of the first/second material bottle; or the end of the sleeve shaped as a straight pipe is provided with internal threads engageable with the external threads formed on the mouth of the first/second material bottle; or the end of the sleeve 3 shaped as a straight pipe is provided with internal threads and external threads respectively engageable with the external threads and internal threads formed on the mouth of the first/second material bottle. A supporting surface 41 and an abutting surface 42 respectively extend from the inner wall of the sleeve 3 toward one end of the sleeve 3. The supporting surface 41, the abutting surface 42, and the inner wall of the sleeve 3 surround a protrusion 4 which has a triangle-shaped cross section. At this time, the mouth of the second material bottle can be clamped in the space defined by the abutting surface 42 and the inner wall of the sleeve 3, preventing the second material bottle and the docking device from swaying.

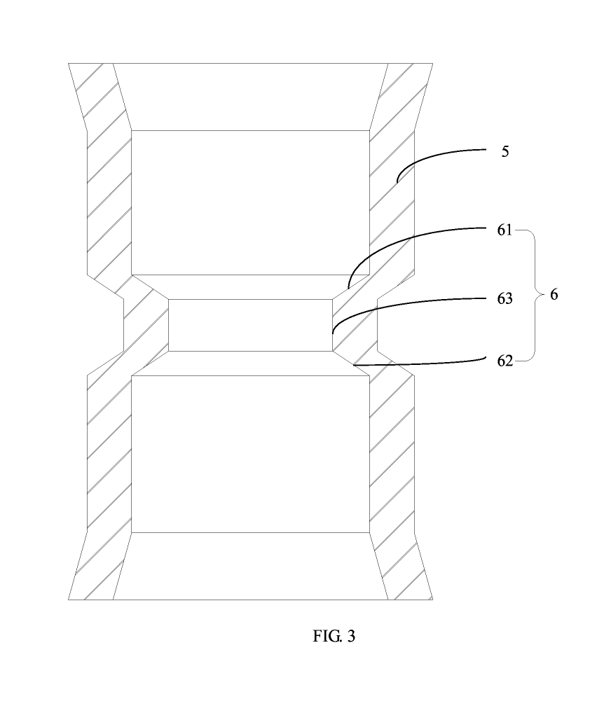

Referring to FIG. 3, a docking device in accordance with a third embodiment is shown. The docking device of the third embodiment is modified based on that of the first embodiment. The docking device of the third embodiment includes a sleeve 5 which has two trumpet-shaped ends and a straight-pipe-shaped middle portion. The sleeve 5 is recessed inwards to define a supporting surface 61, an abutting surface 62, and a connecting surface 63 connecting the supporting surface 61 and the abutting surface 62. The supporting surface 61, the abutting surface 62, the connecting surface 63, and the wall of the sleeve 5 surround a protrusion 6.

The shape of the sleeve and the structure of the protrusion are not limited to the above embodiments, and the shape of the sleeve and the structure of the protrusion can be combined freely.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A docking device for material bottles used for guiding material in a first material bottle to flow into a second material bottle, comprising:
a sleeve with two ends thereof being respectively engageable with mouths of the first material bottle and the second material bottle; and
a protrusion configured in the sleeve for guiding the material in the first material bottle to flow into the second material bottle.

2. The docking device as claimed in claim 1, wherein external threads are formed on the mouth of the first material bottle and/or the mouth of the second material bottle, and internal threads are formed on an inner wall of the sleeve for engaging with the external threads on the mouth of the first material bottle and/or the mouth of the second material bottle.

3. The docking device as claimed in claim 2, wherein one end of the sleeve is shaped as a trumpet and the other end thereof is shaped as a straight pipe.

4. The docking device as claimed in claim 2, wherein both ends of the sleeve are shaped as straight pipes.

5. The docking device as claimed in claim 1, wherein grooves are formed in an inner wall of the sleeve.

6. The docking device as claimed in claim 1, wherein the mouths of the first material bottle and the second material bottle respectively abut two sides of the protrusion.

7. The docking device as claimed in claim 1, wherein the protrusion is a ring protruding from an inner wall of the sleeve, or the protrusion is at least two arcs of a same circumference protruding from an inner wall of the sleeve.

8. The docking device as claimed in claim 7, wherein the protrusion is formed by recessing the sleeve inwards or the protrusion is formed by protruding the sleeve inwards.

9. The docking device as claimed in claim 8, wherein a supporting surface and an abutting surface extend from the inner wall of the sleeve, the protrusion is surrounded by the supporting surface, the abutting surface, and the inner wall of the sleeve; or a supporting surface and a abutting surface extend from the inner wall of the sleeve, a connecting surface connects the supporting surface and the abutting surface, and the protrusion is surrounded by the supporting surface, the abutting surface, and the connecting surface.

10. The docking device as claimed in claim 9, wherein the supporting surface and the abutting surface extend towards one end of the sleeve from the inner wall of the sleeve; or the abutting surface extends towards one end of the sleeve from the inner wall of the sleeve and the supporting surface extends towards the other end of the sleeve from the inner wall of the sleeve.

11. A docking device for material bottles used for guiding material in a first material bottle to flow into a second material bottle, comprising:
a sleeve having an inner wall and two ends, the inner wall forming grooves allowing for air convection between the docking device and external environment, and the two ends being respectively engageable with mouths of the first material bottle and the second material bottle; and
an annular protrusion configured in the sleeve for guiding the material in the first material bottle to flow into the second material bottle.

12. The docking device as claimed in claim 11, wherein external threads are formed on the mouth of the first material bottle and/or the mouth of the second material bottle, and internal threads engageable with the external threads formed on the mouth of the first material bottle and/or the mouth of the second material bottle are formed on the inner wall of the sleeve.

13. The docking device as claimed in claim 12, wherein one end of the sleeve is shaped as a trumpet and the other end thereof is shaped as a straight pipe.

14. The docking device as claimed in claim 12, wherein both ends of the sleeve are shaped as straight pipes.

15. The docking device as claimed in claim 11, wherein the mouth of the first material bottle is received in one end of the sleeve, and the other end of the sleeve is received in the mouth of the second material bottle.

16. The docking device as claimed in claim 11, wherein the protrusion is formed by recessing the sleeve inwards or by protruding the sleeve inwards.

17. The docking device as claimed in claim 11, wherein a supporting surface and an abutting surface extend from the inner wall of the sleeve, the protrusion is surrounded by the supporting surface, the abutting surface, and the inner wall of the sleeve; or a supporting surface and an abutting surface extend from the inner wall of the sleeve, a connecting surface connects the supporting surface and the abutting surface, and the protrusion is surrounded by the supporting surface, the abutting surface, and the connecting surface.

18. The docking device as claimed in claim 17, wherein the supporting surface and the abutting surface extend towards one end of the sleeve from the inner wall of the sleeve; or the abutting surface extends towards one end of the sleeve from the inner wall of the sleeve and the supporting surface extends towards the other end of the sleeve from inner wall of the sleeve.

19. A docking device for material bottles used for guiding material in a first material bottle to flow into a second material bottle, comprising:
a sleeve having two ends for respectively receiving the mouths of the first material bottle and the second material bottle; and
a protrusion configured in the docking device for guiding the material in the first material bottle to flow into the second material bottle, and two sides of the protrusion respectively abutting the mouths of the first material bottle and the second material bottle.

20. The docking device as claimed in claim 19, wherein the protrusion is formed by recessing the sleeve inwards of by protruding the sleeve inwards.
